(19) United States
(12) Patent Application Publication
(10) Pub. No.: US 2005/0210499 A1
(43) Pub. Date: Sep. 22, 2005

(54) Distribution method, distribution program and storage media storing distribution program for contents, and terminal devices, for ad-hoc network

(75) Inventor: Koji Shima, Tokyo (JP)

Correspondence Address: FITCH EVEN TABIN AND FLANNERY, 120 SOUTH LA SALLE STREET, SUITE 1600, CHICAGO, IL, 60603-3406, US

(73) Assignee: Sony Computer Entertainment Inc., Tokyo (JP)

(21) Appl. No.: 11/077,998

(22) Filed: Mar. 10, 2005

(30) Foreign Application Priority Data
Mar. 18, 2004 (JP) 2004-078680

(51) Int. Cl. G06F 3/00; G06F 13/00

(52) U.S. Cl. 725/8

(57) ABSTRACT

A distribution method of a content appropriately collects and supplies usage fees of contents when transmitting/receiving contents between terminal devices on an ad-hoc network. When transmitting/receiving contents between terminal devices, processing of reducing fee information of a content from outstanding amount information stored in a storage medium of the terminal device is performed when receiving the content from another terminal device. At the time of transmitting a content to another terminal device, a virtual outstanding amount information is acquired by subtracting transmit restricting information associated with the transmission of the content from the outstanding amount stored in the storage medium. When the virtual outstanding amount reaches to a predetermined value, transmission of a content to other terminal devices is restricted.

### CROSS REFERENCE TO RELATED APPLICATION

The present application claims priority from Japanese Application No. 2004-078680, filed Mar. 18, 2004, the disclosure of which is hereby incorporated by reference herein in its entirety.

### BACKGROUND OF THE INVENTION

1. Field of the Invention

The present invention relates to a distribution method, a distribution program and storage media storing a distribution program for contents between terminal devices on an ad-hoc network, and terminal devices on an ad-hoc network.

2. Description of the Related Art

In recent years, there is an increasing trend of transmitting/receiving fee-based contents such as music data, picture data, video data, for which secrecy is required, via the Internet. However, the Internet is not necessarily a secure transmission channel. In terms of technology, it is possible to intercept the data transmitted via the Internet, and there is a possibility that a fee-based content may be stolen by someone other than the regular users.

Therefore, in order to realize a safe communication, an encryption technology is utilized. By the use of the technology a content is converted into data, and once converted it is difficult to decipher the data even if an interception by a third party occurs. Recently, an encryption method using a key is frequently used. In the encryption method using a key, the secrecy of data is kept by hiding a key. In other words, a content is encrypted by a key which is commonly shared (hereinafter, simply quoted as a common key) between a server apparatus and a terminal device, and transmitted to a terminal device. The terminal device having received this encrypted content decrypts it by using the same-shared common key, and stores it.

At the time when the terminal device confirms a completion of distribution of all the data, the terminal device transmits a distribution completion notice (billing request) toward the content distribution server. The server which receives the billing request from the terminal device transmits information on the terminal device and the transmitted content (billing information) to a billing server which is managing billing information, and will complete the content distribution.

The content distribution between a server and a terminal device is conducted as it has been described hereinbefore. However, as to a configuration which is operable to relay a wireless transmission signal at each terminal device on a network, a network configuration, in which a wireless transmission can be provided between any terminal devices without using a fixed infrastructure such as a server apparatus, has been proposed. As shown above, a communication channel, which relays data via arbitrary terminal devices on the network without having an access point between them, is known as an ad-hoc network.

However, in case of content distribution through a wireless communication between terminal devices on the ad-hoc network, the communication is performed without passing through content and billing servers. Therefore, after a content stored in a terminal device is distributed to another terminal device, there may be a case that the content received by the other terminal device may be limitlessly re-transmitted to other terminal devices. In the case shown above, there is a problem which needs to be solved in the usage fee of contents, in other words, it is difficult to recover all of the copyright fees and return them to the content providers.

### SUMMARY OF THE INVENTION

The present invention is made in view of the problem described hereinbefore. An object of the present invention is to provide a distribution method, a distribution program and storage media storing a distribution program for contents between terminal devices on an ad-hoc network, and terminal devices on an ad-hoc network, such that it is possible to recover and distribute usage fees of contents when contents are transmitted/received between terminal devices on an ad-hoc network.

When transmission/reception of a content is performed between terminal devices on an ad-hoc network, the present invention calculates virtual outstanding amount information, at the time when a content is transmitted to another terminal device, by subtracting transmit restricting information, which is generated in accordance with the transmission, from outstanding amount information, which is pre-stored in the recording media described above. A feature of the present invention is that a transmission of contents to other terminal devices is restricted when a virtual outstanding amount information is reached to its predetermined value.

In the present invention, virtual outstanding amount information is calculated by subtracting transmit restricting information, which is generated in accordance with the transmission, from outstanding amount information, which is pre-stored in the storage media of a terminal device. Since transmission of contents to other terminal devices is restricted when a value of virtual outstanding amount information is reached to its predetermined value, it is possible to prevent limitless distributions of contents.

Moreover, when a terminal device is connected to a content distribution server apparatus, content distribution information at the time of reception of the content is transmitted to the content distribution server apparatus from the terminal device. The content distribution server apparatus grasps information on the basis of the content distribution information regarding which content is distributed and how many times the content is distributed, and appropriately distributes the usage fees of contents to content providers.

Further, the outstanding amount information, transmit restricting information and virtual outstanding amount information may be stored in the storage media as hash values. Therefore, there is a merit exist that secrecy can be established with a small amount of data.

Artisan will fully understand that the above and further objects and features of the present invention by reading preferred embodiments of the invention described herein in connection with the accompanying drawings, including features recited in the appended claims, as well as explicit and implicit effects and advantages of the invention, including those to be apparent through implementation of the invention.

### BRIEF DESCRIPTION OF THE DRAWINGS

FIG. 1 is a diagram schematically showing an ad-hoc network of a first embodiment including server apparatuses;

FIG. 2 is a functional block diagram of each terminal device in the first embodiment;

FIG. 3 is a circuit block diagram of each terminal device in the first embodiment;

FIGS. 4A and 4B are explanatory diagrams schematically showing an outstanding amount, contents, and the like of the terminal devices in the first embodiment;

FIG. 5 is an explanatory diagram showing distribution processing between the terminal devices in the first embodiment;

FIG. 6 is a flowchart showing distribution processing of a content in the first embodiment;

FIGS. 7A and 7B are explanatory diagrams schematically showing an outstanding amount, contents, and the like of each terminal device in a second embodiment;

FIGS. 8A, 8B, and 8C are explanatory diagrams schematically showing an outstanding amount, contents, and the like of the terminal devices in the second embodiment;

FIG. 9 is an explanatory diagram showing distribution processing of a content between the terminal devices in the second embodiment; and

FIG. 10 is a flowchart showing distribution processing of contents in the second embodiment.

### DETAILED DESCRIPTION OF THE PREFERRED EMBODIMENTS

A preferred embodiment of the present invention is described below with reference to accompanying drawings. It is noted that like parts or elements are designated by like reference characters in the drawings, without redundant description of the parts or elements.

### [First embodiment]

[Configuration of Ad-hoc Network]

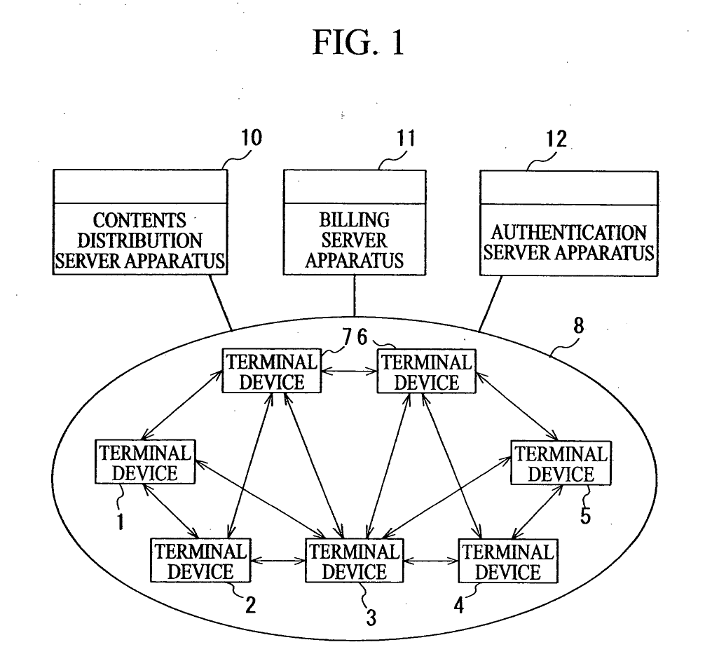

FIG. 1 is a diagram schematically showing an ad-hoc network of a first embodiment of the present invention including server apparatuses. In FIG. 1, terminal devices 1 to 7 consist of an ad-hoc network 8. A plurality of terminal devices 1 to 7 can be connected each other without having a base station or an access point between them. On this ad-hoc network 8 servers, such as a content distribution server apparatus 10, a billing server apparatus 11 and an authentication server apparatus 12 are connected.

Each terminal device 1 to 7 is equipped with a function which enables the terminal device to relay transmission of a signal which is transmitted by another terminal device within the ad-hoc network 8. Therefore, it is possible to perform a bi-directional data transmission between the terminal devices 1 to 7 within the ad-hoc network 8. Each terminal device 1 to 7 can be either a fixed terminal device, such as a personal computer the location of which is fixed, or a portable terminal device which is configured mobile. If it is a portable terminal device, various types of portable machines, such as a cellular phone or a portable digital assistant (PDA), can be used as a terminal device.
[Configuration of Terminal Device]

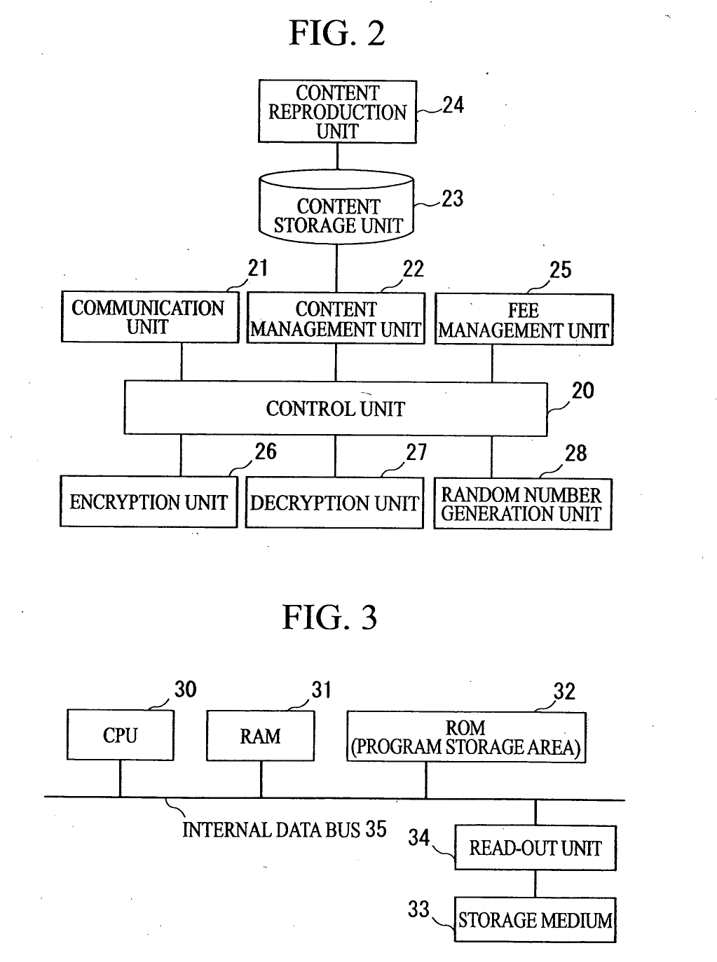

FIG. 2 is a functional block diagram of each terminal device 1 to 7. As shown in FIG. 2, for example, the terminal device 1 comprises: a communication unit 21, which has capability of a wireless communication between terminal devices 2 to 7 without a server apparatus between them; a content management unit 22, which controls contents transmitting/receiving between the other terminal devices 2 to 7; a content storage unit 23, which stores contents; a content reproduction unit 24, which reproduces content with audio and video; a fee management unit 25, which manages fees during transmitting/receiving contents; an encryption unit 26, which encrypts information, which is later described, such as outstanding amount information, transmit restricting information, and virtual outstanding amount information, by using hash values for example; a decryption unit 27, which decrypts encrypted information; a random number generation unit 28, which generates a random number; and a control unit 20, which controls each unit in an integrated manner. With this control unit 20, processing at each processing step is controlled.

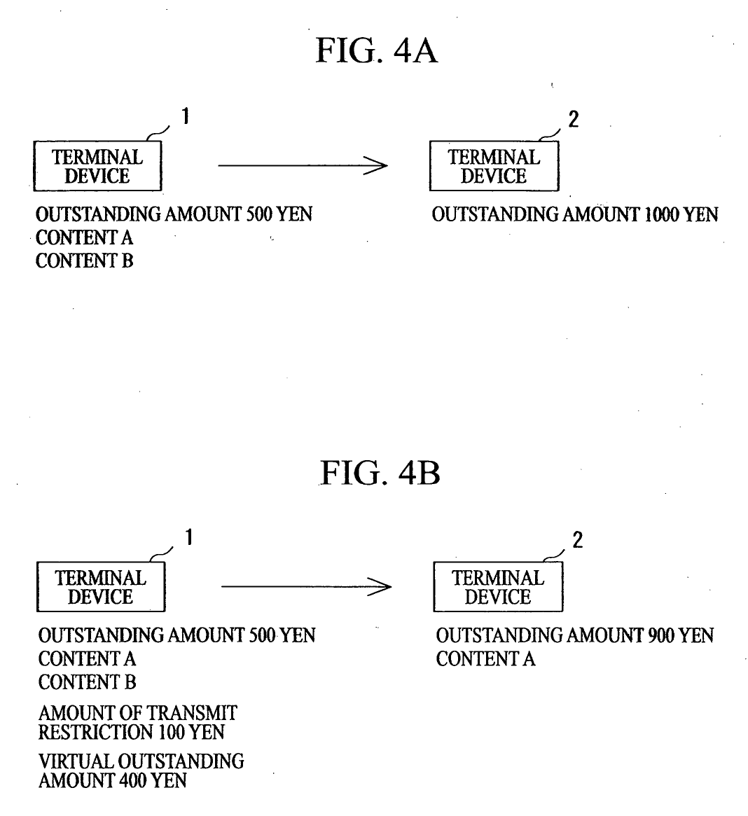

FIG. 3 is a circuit block diagram of each terminal device 1 to 7. As shown in FIG. 3, each terminal device 1 to 7 comprises: a central processing unit (hereinafter, abbreviated as CPU) 30, which executes a content distribution program and control program; a random access memory (hereinafter, abbreviated as RAM) 31, which temporarily stores various data; a read only memory (hereinafter, abbreviated as ROM) 32, which stores a content distribution program and control program; a read-out unit 34, which reads out data from storage media 33 and write data in the storage media 33; and an internal bus 35.

In the present invention, transmission/reception of a content is performed between the terminal devices 1 to 7 which configure an ad-hoc network. However, preceding it, it is necessary that some of the terminal devices 1 to 7 needs to be distributed a content from the content distribution server apparatus 10. Alternatively, it is also possible to buy a storage medium 33 in which a content is stored and to implement it into any one of the terminal devices 1 to 7. When the arrangement for transmitting/receiving a content is set up, the terminal device 1, for example, transmits a content to another terminal device 2, and a usage fee of the transmitted content is charged to a user of the terminal device 2 to which the content is distributed. Therefore, in the terminal devices 1 to 7, an operation of depositing electronic money to the storage media 33 is performed in advance. The process of deposition is described as follows.
[Depositing Operation to Storage Media]

First, a terminal device 1 equipped with an ultra small storage medium 33, for example, such as a “Memorystick” (Trademark) or a SD card is connected to a billing server 11 via an encrypted channel through a communication unit 21. Thus, an outstanding amount of the storage medium 33 is to be confirmed. Here, the billing server is an electronic money settlement site which utilizes, for example, web money or a credit card. Next, an amount of money to be deposited is encrypted by an electronic money private key in the public key system at an encryption unit 26, and stored in the storage medium 33. In this process, additionally, a unique ID of the storage medium 33, which is to be described later, can be used to further encrypt it.

When the electronic money stored in the storage medium 33 is used, in other words, when a content is distributed, an outstanding amount is extracted after decrypting at an decryption unit 27 by using the electronic money public key attached to the distributed content. Incidentally, the electronic money public key can be transferred at the time of depositing operation. However, even under the circumstances, it needs to be verified by comparing with the electronic money public key attached to the content. If there are some outstanding amount left for use, an amount of money used by a user after purchasing a content is stored. Here, the amount of money is encrypted at the storage medium 33 by the unique ID. It should be noted that to the storage medium 33 a unique ID is preliminarily attached. The unique ID is not an ID of the terminal device 1 but it is given to respective storage media 33.

An amount of money used is stored as a hash value. This hash value is obtained by corresponding a character string consisting of an amount of money used and unique ID with numeral value using a hash function. As a hash function, a unidirectional function, such as “SHA-1”, “MD5” and the like can be typically used. By using a hash value, the secrecy of information is enhanced without having a capability of a reverse directional calculation. Moreover, comparing with the utilization of a public key and private key in an open key system, the amount of data in the use of a hash value is smaller. Thus, it is preferable for using in the respective terminal devices 1 to 7.

When reading out an amount of money used, estimation by substituting an amount of money used sequentially one after the other is used, since calculation in reverse direction is not usable. This calculation can be executed within several seconds once the upper limit of an outstanding amount is pre-fixed. Note that in order to avoid a re-use of the past hash value and data stored in the storage medium 33, a pseudo random number is used on the basis of a seed given by, for example, a unique ID.
[Distribution of content from contents distribution server apparatus to terminal device]

Next, a case in which a terminal device 1 is distributed a content by a contents distribution server apparatus 10 is described.

The content distribution from the contents distribution server apparatus 10 can be made to any terminal devices 1 to 7. When the terminal device 1 is distributed a content, as shown in FIGS. 1 and 2, a communication unit 21 of the terminal device 1 is connected to the contents distribution server apparatus 10 via predetermined network such as the Internet. Then, an authentication server apparatus 12 authenticates connections of the terminal device 1 whether it is made by a normal user who is authorized for the connection. When the user is authenticated as a normal user, a requested content is distributed from the contents distribution server apparatus 10 to the terminal device 1, and stored in a content storage unit 23. Depending on the distribution of a content, a billing server apparatus 11 charges predetermined fee to the terminal device 1, and performs reduction processing of the fee out of the outstanding amount in electronic money stored in the storage medium 33. What is described hereinbefore is the same as in the conventional content distribution systems.
[Distribution of content from a terminal device to other terminal devices]

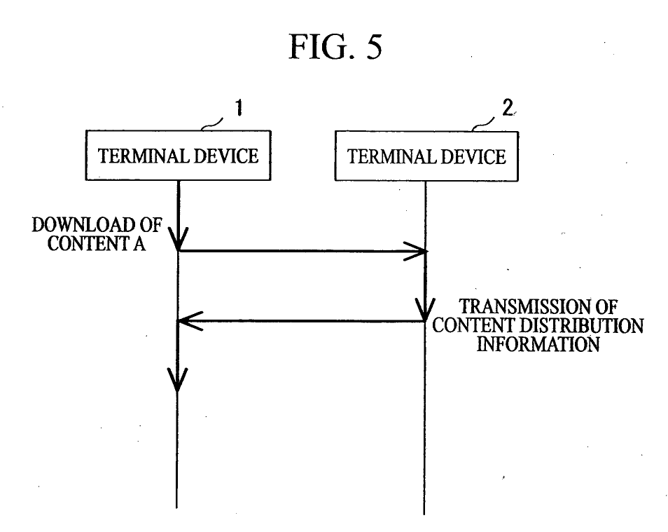

Next, a case in which a content stored in a content storage unit 23 of a terminal device 1 is distributed to other terminal device 2 is described by the use of FIGS. 4A and 4B to FIG. 6.

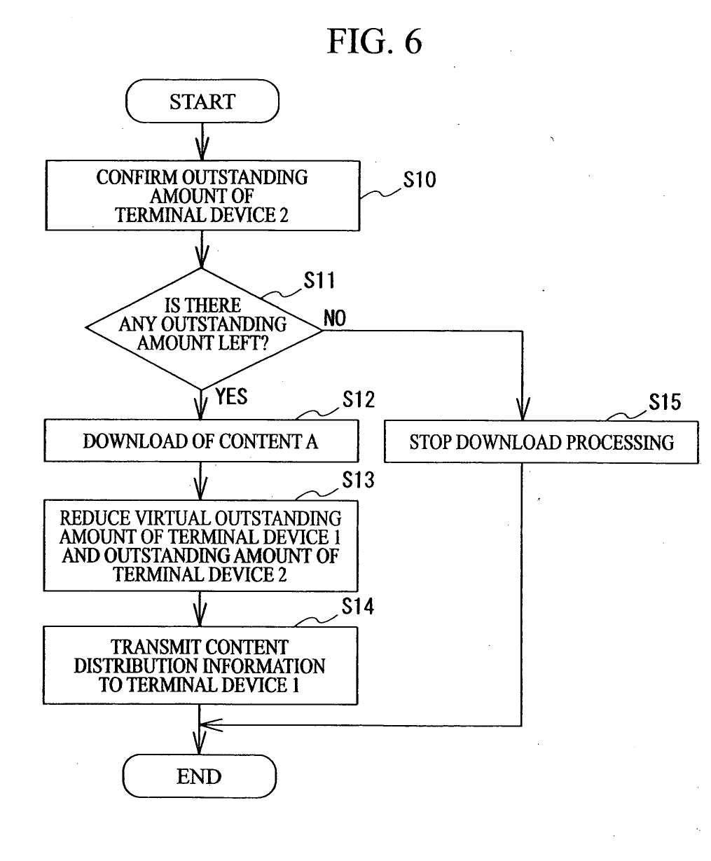

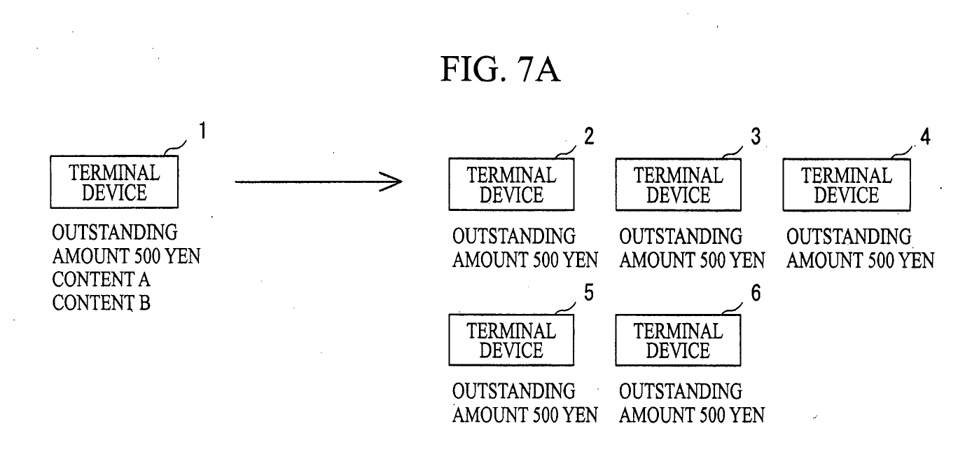

FIGS. 4A and 4B are explanatory diagrams schematically showing an outstanding amount, contents, and the like of the terminal devices 1 and 2. FIG. 5 is an explanatory diagram showing distribution processing between the terminal devices 1 and 2. FIG. 6 is a flowchart showing distribution processing of a content. In these figures, an outstanding amount in the terminal device 1 is, for example, 500 yen as outstanding amount information. The content A and content B have already been distributed from the contents distribution server apparatus 10, and stored in the content storage unit 23 of the terminal device 1 (FIG. 4A). Note that the usage fees of the content A and content B is 100 yen, respectively.

When the terminal device 2 requests the terminal device 1 to distribute, for example, content A, first, in processing of step S10 the terminal device 2 transmits outstanding amount information to the terminal device 1. At the terminal device 1, a comparison is made between the received outstanding amount information and the price information of the content. As a result of the comparison, in the processing of step S11 when the outstanding amount information exceeds the usage fee of the content A, in other words, when there is an outstanding amount left for use, the terminal device 1, in processing of step S12, permits distribution of the content A to the terminal 2. Alternatively, it is also acceptable that in the terminal device 2, a usage fee of a content is acquired in advance, and then comparison is made between the usage fee and the outstanding amount information stored in the storage medium 33 at a fee management unit 25 of the terminal device 2. The result of the comparison is transmitted to the terminal device 1.

Next, in processing of step S13, the outstanding amount 1000 yen of the terminal device 2 is reduced by subtracting 100 yen for the usage fee of the content A to end up to 900 yen (FIG. 4B). At the fee management unit 25 of the terminal device 2, a series of processing of writing the modification of the outstanding amount in sequence in the storage medium 33 without overwriting a new amount onto it, and thus storing in memory, are conducted under the control of the control unit 20.

Meanwhile, in the terminal device 1 the outstanding amount does not change, but a new concept, that is, “transmit restricting information” and “amount of transmit restriction” is introduced in order to provide restrictions of limitless distributions of content A to other terminal devices 2 to 7. For example, for each distribution of a content to the other terminal devices 2 to 7 from the terminal device 1 predetermined amount of transmit restriction is subtracted from the outstanding amount of the terminal device 1 to obtain “virtual outstanding amount”. In other words, a virtual outstanding amount K is obtained by the use of the following equation (1).
[outstanding amount Z]−A×[amount of transmit restriction S]=[virtual outstanding amount K] (1)
Here, the virtual outstanding amount K is a predetermined value, such as zero or a positive number. Moreover, “A” is a predetermined coefficient and can be set to a various value except zero depending on a sort of content. Hereinafter, descriptions are made as “A” is equal to 1. When the virtual outstanding amount of the terminal device 1 becomes zero after distributing contents to many other terminal devices 2 to 7, it is not possible for the terminal device 1 to transmit contents to other terminal devices any more. Therefore, it is possible to restrict limitless distributions beyond the limit of virtual outstanding amount.

In the terminal device 1, by distributing content A to the terminal device 2 the virtual outstanding amount turns to be 400 yen after subtracting an amount of transmit restriction of 100 yen from the outstanding amount of 500 yen in accordance with the equation (1) (FIG. 4B). Note that the amount of transmit restriction is the same price as that of the usage fee of distributed content.

Next, in processing in step S14, information which indicates a result of the distribution of content A from the terminal device 1 to the terminal device 2, that is, distribution information specifying content A is transmitted from the terminal device 2 to the terminal device 1. This content distribution information is represented by a long string of characters as that of a common key used in a common key encryption system in which a common key is used for encryption and decryption. Alternatively, it is also possible to use a hash value derived from all the content keys included in the content. Further, it can be a hash value of “a content ID+all the content keys” which is given to each content. It should be noted that although the content itself is encrypted and the encryption and decryption are performed with a public key and private key, the use of the all content keys is preferable because of the smaller amount of data involved compared with the use of a public key and private key. Incidentally, processing of step S13 and S14 are conducted almost at the same time, but if in step S14 the network is cut off, the entire states resume to states before the distribution because of a highly probable failure in distribution.

In the terminal device 2 which is distributed content A as has been described hereinbefore, at a content reproduction unit 24, audio and video are reproduced from content A.

It should be noted that in processing of step S15 when the outstanding amount of the terminal device 2 is zero, it is impossible to be distributed a content from other terminal devices and the distribution processing is terminated.

Moreover, in the above description, the case in which processing is performed following the steps S12 to S14 is shown. However, the present invention is not restricted by the processing sequence but rather processing can be performed in various other forms of steps such as reducing an outstanding amount of a terminal prior to a distribution of content.

### [Second Embodiment]

As has been described in the first embodiment, a terminal device a virtual outstanding amount of which is zero cannot be distributed a content from other terminal devices. However, it is considered to be unreasonable not to be distributed a content despite of a remaining outstanding amount. Therefore, it is determined that the transmit restricting information regarding an amount of transmit restriction can be transmitted to other terminal devices, and thus increasing the virtual outstanding amount so that a distribution of a content is made possible.
[Distribution of content by transmitting transmit restricting information]

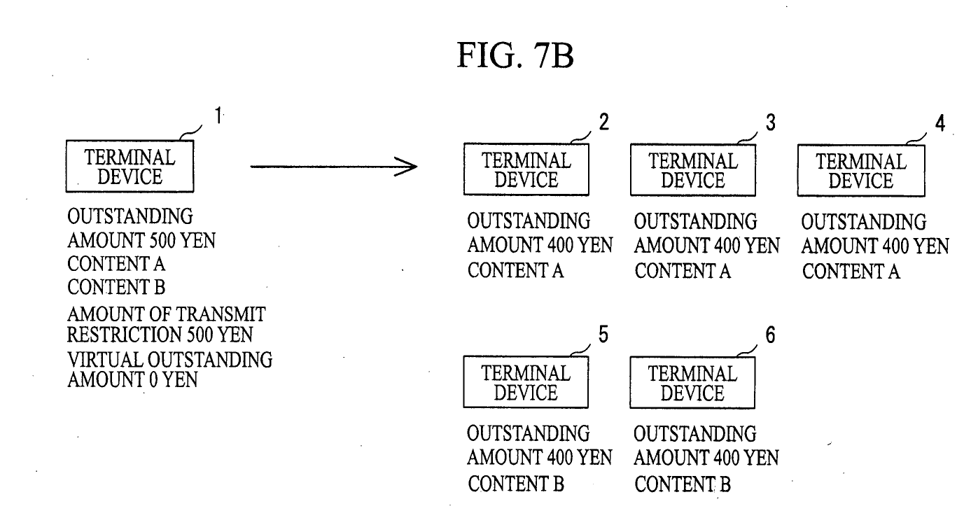

Hereinafter, a distribution of content in a second embodiment as shown before is described with reference to FIGS. 7 to 10.

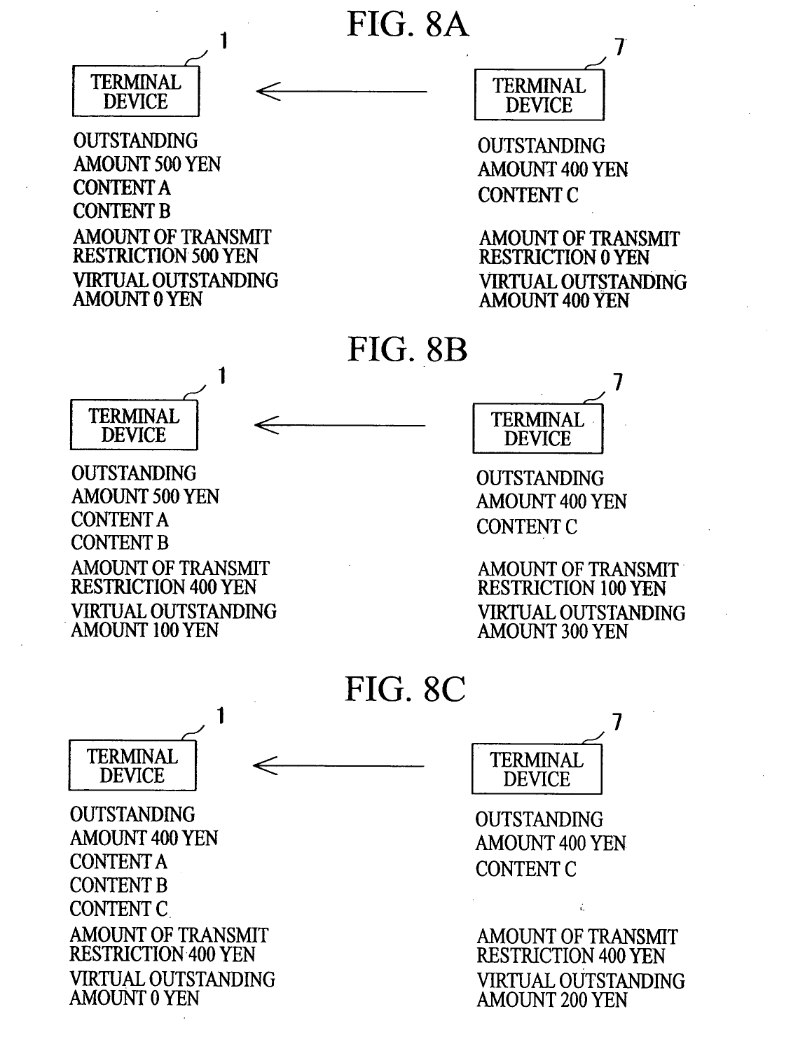

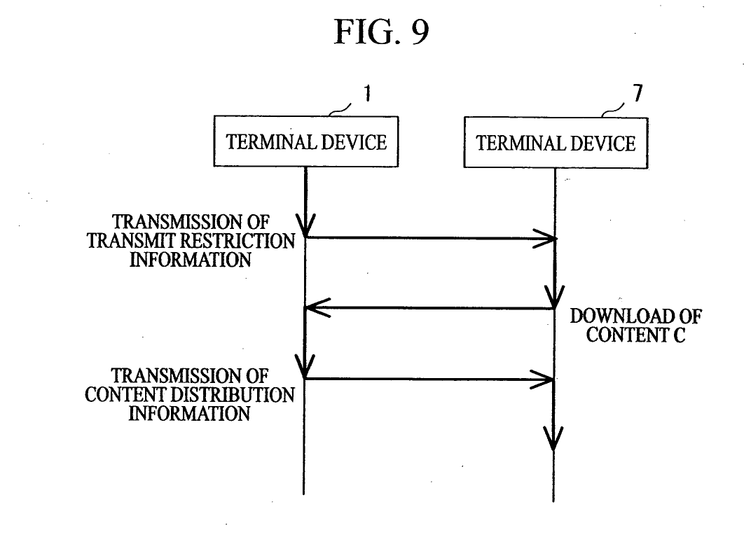

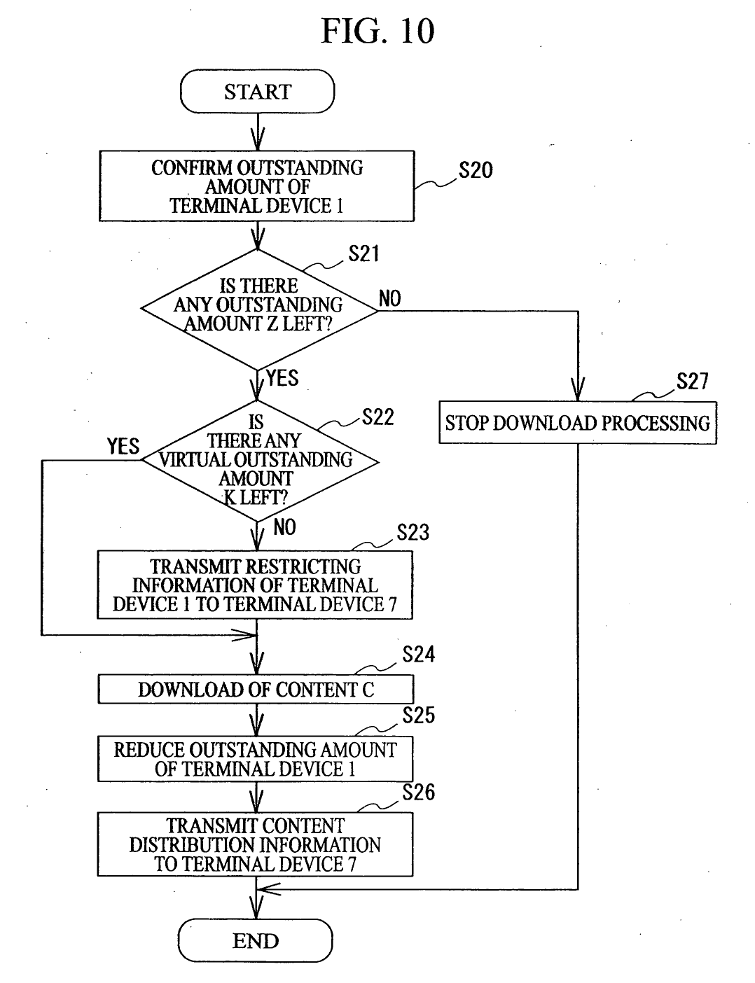

FIGS. 7A and 7B are explanatory diagrams schematically showing an outstanding amount, contents, and the like of the terminal device 1 and the terminal devices 2 to 6. FIGS. 8A, 8B, and 8C are explanatory diagrams schematically showing an outstanding amount, contents, and the like of terminal devices 1 and 7. FIG. 9 is an explanatory diagram showing distribution processing of a content between the terminal device 1 and 7. FIG. 10 is a flowchart showing distribution processing of contents.

In these figures, it is assumed that the terminal device 1 distributes content A to other terminal devices such as the terminal devices 2 to 4, and distributes content B to the terminal devices 5 and 6. The terminal device 1 holds an outstanding amount of 500 yen and stores content A and content B in the content storage unit 23 (FIG. 7A). First, by the use of a fee management unit 25 of respective terminal devices 2 to 6, outstanding amount thereof in the respective storage medium 33 is confirmed. The outstanding amount of the terminal devices 2 to 6 is 500 yen respectively. Therefore, it is possible to distribute a content.

As a result of the distribution of content A and content B from the terminal device 1, as shown in FIG. 7B, the outstanding amount of the terminal devices 2 to 6 is reduced to 400 yen respectively. On the other hand, since the terminal device 1 has not received distribution of a content, the outstanding amount does not change from 500 yen. However, since the terminal device 1 has distributed content A to the other terminal devices 2 to 4 and content B to the terminal devices 5 and 6, the amount of transmit restriction is now 500 yen and the virtual outstanding amount becomes zero yen according to the above equation (1). In this state, since the virtual outstanding amount of the terminal device 1 is already zero yen, it is not possible to distribute contents to other terminal devices. Moreover, though the outstanding amount is 500 yen, if the terminal device 1 receives distribution of a content from another terminal device, the virtual outstanding amount will become a negative value. Therefore, it is not possible for the terminal device 1 to receive distribution of a content. In this way, in order to avert inconvenience not to be distributed a content despite of some residual outstanding amount, it is determined that the transmit restricting information regarding an amount of transmit restriction can be transmitted to other terminal devices.

The terminal device 1 in FIG. 8A is in the same state as that of the terminal device 1 in FIG. 7B. When the terminal device 1 wants to receive distribution of content C from the another terminal device 7, first, in processing of step S20 in FIG. 10, an outstanding amount stored in the storage medium 33 is confirmed at the fee management unit 25 of the terminal device 1. In processing of step S21, as a result of investigation whether an outstanding amount Z is left over or not, if it is confirmed that there are an outstanding amount sufficient for the usage fee of content C in terminal device 1, the virtual outstanding amount K is checked at the fee management unit 25 in terminal device 1 in the subsequent processing of step S22. As a result, when the virtual outstanding amount K is lesser than the usage fee of a content, the transmit restricting information stored in the storage medium 33 of terminal device 1 is transmitted to the terminal device 7 via the communication unit 21 in the processing of step S23.

Specifically, supposing that the usage fee of content C is 100 yen, an amount of transmit restriction of 100 yen is transmitted from the terminal device 1 to the terminal device 7. Then, the amount of transmit restriction in the terminal device 1 becomes 400 yen from the previous 500 yen and the virtual outstanding amount becomes 100 yen from the previous zero yen (FIG. 8B). On the other hand, in the terminal device 7, after receiving an amount of transmit restriction from the terminal device 1, the amount of transmit restriction becomes 100 yen from the previous zero yen and the virtual outstanding amount becomes 300 yen. In this state, since the virtual outstanding amount of the terminal device 1 is 100 yen, it becomes possible to distribute content C from the terminal device 7. Note that the terminal device 7 which receives the amount of transmit restriction does not burden by itself but resolves this amount by connecting to a contents distribution server apparatus 10 which will be described hereinafter.

Next, in processing of step S24, the terminal device 7 distributes content C to the terminal device 1. In processing of step S25, the outstanding amount of the terminal device 1 is reduced to 400 yen from the previous 500 yen, and then, the virtual outstanding amount becomes zero yen (FIG. 8C). Meanwhile, in terminal device 7, after distributing content C, the amount of transmit restriction increases to 200 yen from the previous 100 yen and the virtual outstanding amount becomes 200 yen. Subsequently, in processing of step S26, content distribution information indicating the result of distribution of content C is transmitted from the terminal device 1 to the terminal device 7.

In the processing of step S22 described hereinbefore, when the virtual outstanding amount K is more than the usage fee of content, after distributing content C from the terminal device 7 in the processing of step S24, the outstanding amount of the terminal device 1 is reduced in processing of step S25. Next, in processing of step S26, content distribution information indicating the result of distribution of content C is transmitted from the terminal device 1 to the terminal device 7.

Note that, in processing of step S21, if the outstanding amount Z is less than the usage fee of a content, distribution processing is terminated in processing of step S27 since it is impossible to receive distribution of content. Moreover, when the virtual outstanding amount K of the terminal device 7 becomes less than the usage fee of content C in step S23, the terminal device 7 cannot distribute content C, therefore but the terminal device 1 dose not transmit the transmit restricting information transmitted by the terminal device 1 stays as it is after transmitted to the terminal device 7 and the distribution processing is terminated.

Moreover, a description has been given in the case of processing according to the steps S23 to S26. The present invention is not restricted with these processing steps but rather it is possible to perform processing in various forms of embodiments. For example, after distributing a content the transmit restricting information may be transmitted; before distributing a content the outstanding amount on a terminal device is reduced in advance; transmit restricting information and content distribution information may be transmitted simultaneously; and the like.
[Connection from terminal device to content distribution server apparatus]

Incidentally, at the side of the content distribution server apparatus 10 usage fees of contents distribution need to be supplied to contents providers in cooperation with the billing server apparatus 11. On the ad-hoc network 8, due to repetitive operations of content distribution between the terminal devices, the amount of transmit restriction is accumulated on the ad-hoc network 8 as a whole. Thus, there arises a situation that content distribution between the terminal devices becomes impossible.

Under the circumstances, the problem could be solved by making a connection to the contents distribution server apparatus 10 by a user who newly wants to have a content distribution. That is, when a terminal device connects to the contents distribution server apparatus 10, an information which resolves an amount of transmit restriction stored in the storage medium 33 of the connected terminal device is transmitted from the contents distribution server apparatus 10 to the terminal device. By doing so, the virtual outstanding amount becomes equal to the outstanding amount.

Moreover, the content distribution information at the time of distributing content which is stored in the storage medium 33 is transmitted to the contents distribution server apparatus 10 from the communication unit 21 of the terminal device. Since it is possible in the contents distribution server apparatus 10 to acquire information on, which content is distributed how many times and the content fees involved, based on the received content distribution information, appropriate supply of the fees to the content providers can be conducted on the day of a final operation of the server apparatus or an account day.

It should be noted that the amount of transmit restriction need not be born by the user holding the terminal device, rather it is used to restrict the content distribution. Therefore, in order to promote resolution of an amount of transmit restriction by making connections positively from a terminal device to the contents distribution server apparatus 10, it can also be considered that a part of the amount of transmit restriction is returned as an outstanding amount or some other benefits are rewarded to the users.

Furthermore, it is possible to include within the content distribution information not only the hash values of the content described before (for example, a hash value of the content itself and hash values of the content key) but also a hash of the storage medium 33, which is a new hash constituting of hash of a unique ID of the storage medium 33, such as a Memorystick (Trademark), and a hash of the content. This is to avoid replay attacks to the contents distribution server apparatus 10 and makes it possible to include the hash value as an object to be managed. In other words, the contents distribution server apparatus 10 finds out the corresponding content by this content hash value and stores a hash value of the storage medium 33 for each content.

While preferred embodiments of the present invention have been described using specific terms, such description is for illustrative purposes, and it is to be understood that changes and variations may be made without departing from the spirit or scope of the following claims.

The content of Application No. TOKUGAN 2004-78680 which was filed in Japan on Mar. 18, 2004 and on which the claim to priority for this application is based, is hereby incorporated by reference.

1. A content distribution method on an ad-hoc network, comprising the steps of:
comparing between an outstanding amount in a second terminal device and fee information of a content when the second terminal device requests the content distribution stored in a first terminal device;
permitting the content distribution to the second terminal device by the first terminal device when the outstanding amount information exceeds the fee information of the content;
obtaining a virtual outstanding amount information by subtracting transmit restricting information due to the content distribution from outstanding amount information stored in a storage medium of the first terminal device; and
restricting the content distribution from the first terminal device to other terminal devices, when the virtual outstanding amount information reaches to a predetermined value.

2. The content distribution method according to claim 1, wherein in the step of comparing, the outstanding amount information of the second terminal device is transmitted to the first terminal device and the first terminal device compares between the received outstanding amount information and the fee information of the content.

3. The content distribution method according to claim 1, further comprising the step of:
subtracting the fee information of the content from the outstanding amount information stored in a storage medium of the second terminal device.

4. The content distribution method according to claim 1, wherein
transmit restricting information stored in a storage medium of the first terminal device is capable of transmitting to other terminal devices.

5. The content distribution method according to claim 1, wherein
transmit restricting information stored in a storage medium of the first terminal device is transmitted to a content distribution server from the first terminal device; and
information for resolving transmit restriction is transmitted from the content distribution server to the first terminal device.

6. The content distribution method according to claim 1, further comprising the steps of:
transmitting content distribution information specifying a content received by the second terminal device to the first terminal device; and
transmitting the content distribution information from the first terminal device to the content distribution server apparatus when the first terminal device is connected to the content distribution server apparatus.

7. The content distribution method according to claim 1, wherein
the outstanding amount information, transmit restricting information, and virtual outstanding amount information are stored in the storage medium as a hash value.

8. The content distribution method according to claim 1, wherein
in a step of acquiring the virtual outstanding information, the virtual outstanding information is acquired by subtracting a value, which is obtained by multiplying a predetermined coefficient to transmit restricting information associated with content distribution, from outstanding amount information stored in a storage medium of the first terminal device.

9. A terminal device capable of transmitting/receiving a content one another on an ad-hoc network, comprising:
a communication unit for performing wireless communication with other terminal devices;
a content storage unit for storing a content;
a content reproduction unit for reproducing a content stored in the content storage unit;
a fee management unit for managing fee information stored in a storage medium; and
a control unit for obtaining a virtual outstanding amount information by subtracting transmit restricting information due to content distribution from outstanding amount information stored in the storage medium when the content is transmitted to other terminal devices, and for controlling content transmission to other terminal devices when the fee management unit determines that the virtual outstanding amount information reaches to a predetermined value.

10. The terminal device according to claim 9, wherein
the control unit controls the fee management unit to subtract fee information of a content from outstanding amount information stored in the storage medium when receiving the content from other terminal devices.

11. The terminal device according to claim 9, wherein
the control unit performs control of transmission of transmit restricting information stored in the storage medium to other terminal devices by use of the communication unit.

12. The terminal device according to claim 9, wherein the control unit performs control of:
transmission of transmit restricting information stored in the storage medium to a content distribution server apparatus by use of the communication unit; and
reception of information for resolving transmit restriction from the content distribution server apparatus.

13. The terminal device according to claim 9, wherein
the control unit performs control of transmission of content distribution information specifying a content received from other terminal devices to a content distribution server apparatus by use of the communication unit.

14. The terminal device according to claim 9, wherein
the outstanding amount information, transmit restricting information, and virtual outstanding amount information are stored in the storage medium as a hash value.

15. The terminal device according to claim 9, wherein
the virtual outstanding information is acquired by subtracting a value, which is obtained by multiplying a predetermined coefficient to transmit restricting information associated with content distribution, from outstanding information stored in the storage medium.

16. A computer readable storage medium storing a program for distributing a content in a terminal device on an ad-hoc network, the program comprising the steps of:
performing wireless communication with other terminal devices by a communication unit;
storing a content by a content storage unit;
reproducing a content stored in the content storage unit by a content reproduction unit;
managing fee information stored in a storage medium by a fee management unit;
obtaining a virtual outstanding amount information by subtracting transmit restricting information due to content distribution from outstanding amount information stored in the storage medium by use of a control unit when the content is transmitted to other terminal devices; and
controlling content transmission to other terminal devices by use of the control unit when the fee management unit determines that the virtual outstanding amount information reaches to a predetermined value.

17. The computer readable storage medium according to claim 16, wherein
the control unit performs control of the fee management unit, when receiving a content from other terminal devices, such that the fee management unit subtracts fee information of the content from the outstanding amount information stored in the storage medium.

18. The computer readable storage medium according to claim 16, wherein
the control unit performs control of transmission of transmit restricting information stored in the storage medium to other terminal devices by use of the communication unit.

19. The computer readable storage medium according to claim 16, wherein the control unit performs control of:
transmission of transmit restricting information stored in the storage medium to a content distribution server apparatus by use of the communication unit; and
reception of information for resolving transmit restriction from the content distribution server apparatus.

20. The computer readable storage medium according to claim 16, wherein
the control unit performs control of transmission of content distribution information specifying a content received from other terminal devices to a content distribution server apparatus by use of the communication unit.

21. The computer readable storage medium according to claim 16, wherein
the outstanding amount information, transmit restricting information, and virtual outstanding amount information are stored in the storage medium as a hash value.

22. The computer readable storage medium according to claim 16, wherein
the virtual outstanding information is acquired by subtracting a value, which is obtained by multiplying a predetermined coefficient to transmit restricting information associated with content distribution, from outstanding information stored in the storage medium.
